(19) United States
(12) Patent Application Publication
(10) Pub. No.: US 2006/0083199 A1
(43) Pub. Date: Apr. 20, 2006

(54) System, method, and device for handing off between voice over internet protocol over wireless access sessions and CDMA circuit switched voice sessions

(76) Inventor: Jianhao Michael Yang, San Diego, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/966,425

(22) Filed: Oct. 15, 2004

(51) Int. Cl. H04Q 7/00; H04B 7/216

(52) U.S. Cl. 370/331; 370/335; 370/342

(57) ABSTRACT

Provided are improved systems, methods, and devices for handing off VoIP sessions and CDMA voice calls between wireless access networks and CDMA networks, thereby providing a user of a mobile device the ability to roam between wireless access networks and CDMA circuit switched voice networks during ongoing communication sessions. Provided are network architectures and process frameworks that enable seamless handoff between VoIP and circuit switched CDMA voice, including messages and procedures to facilitate such handoffs. Importantly, the voice traffic is not interrupted, and the handoff process may be automatic and transparent to the users of the communication session.

### FIELD OF THE INVENTION

The present invention relates generally to voice over internet protocol (VoIP) communications and, more particularly, to systems, methods, and devices for handing off between voice over internet protocol (VoIP) over wireless access sessions and circuit switched Code Division Multiple Access (CDMA) sessions.

### BACKGROUND

Voice over Internet protocol (VoIP), also referred to as Internet telephony, IP telephony, and Voice over the Internet (VoI), has recently become more popular. For example, advances in wireless access technologies, such as the 802.11 standards, have prompted increasing use and deployment of VoIP products and services. VoIP can function on different wired and wireless access sessions, including, for example, 802.11 wireless LAN (WLAN), 802.16 WiMAX, and Bluetooth sessions. VoIP can provide voice service at a reduced cost and increase coverage such as inside buildings and provides the potential for combined voice and data service over large bandwidths such as offered by WLAN sessions. VoIP using wireless access sessions can be viewed as an extension of existing cellular networks.

As an extension of existing cellular networks, one challenge for carriers and other service providers is providing a user the ability to roam between wireless access networks which are packet switched and conventional cellular circuit switching networks, just as existing users are able to roam throughout a cellular network and across cellular networks. Specifically, this involves the handoff of a communication session from the wireless access VoIP session on a packet switched data network to a Code Division Multiple Access (CDMA) voice session on a circuit switching voice network, or from a CDMA circuit switched voice session to a wireless access VoIP session.

Although standards may eventually be released and/or hardware implemented to support VoIP using wireless access in conjunction with cellular networks, such as VoIP over CDMA1x Evolution Data and Voice (EV-DV) or Evolution Data Only (EV-DO) as proposed by the 3GPP2 organization, at least for the near future, cellular networks continue to be circuit switching networks which do not support VoIP and handoff of VoIP to and from a wireless access network. Even if alternative network structures are implemented in the future, those technologies cannot be implemented instantaneously, but will likely be implemented incrementally over time. Thus, VoIP sessions, such as VoIP over WLAN (VoWLAN) wireless access sessions, require backwards compatibility, including seamless voice service continuation, with existing CDMA cellular networks.

Accordingly, there is a need in the art for an improved framework for communication session handoff between VoIP and CDMA circuit switched networks.

### SUMMARY

In light of the foregoing background, embodiments of the present invention provide improved systems, methods, and devices for handing off between voice over internet protocol (VoIP) over wireless access sessions and Code Division Multiple Access (CDMA) circuit switched voice sessions, thereby providing a user the ability to roam between wireless access and CDMA circuit switched voice networks. The present invention provides a framework that enables seamless handoff between VoIP and a circuit switched CDMA voice session, including messages and procedures to facilitate such handoffs. Importantly, the voice traffic is not interrupted, and the handoff process may be automatic and transparent to the users of the communication session.

While handoff of a communication session from a CDMA session to a wireless access session is also desired, handoff of a communication session from the wireless access session to a CDMA session would appear to be of particular importance given the likelihood of roaming between the standards. For example, because WLAN coverage is typically much smaller than the coverage of a CDMA base station, a user who starts a VoWLAN call may easily roam out of the WLAN coverage and want to handoff to CDMA base station coverage. By comparison, a user who starts a circuit switched call in CDMA coverage may not need or want to handoff into WLAN coverage to switch to VoWLAN when WLAN coverage is available, as long as CDMA coverage is still available. However, a complete solution for wireless access VoIP and CDMA circuit switched (CS) voice interworking should provide roaming to and from CDMA sessions. By including seamless roaming from CDMA to wireless access VoIP, a user can take advantage of lower costs of wireless access VoIP, such as VoWLAN where WLAN coverage is available.

According to one aspect of the present invention, embodiments of methods for handing-off voice communication sessions between VoIP over a wireless access network and a circuit switched CDMA network are provided. Methods of the present invention may include an initial step of requesting handoff of the communication session from the wireless access network to the CDMA network, which request may include transferring end node configuration information and CDMA network information. The method may further include the steps of adding a trunk connection for a CDMA communication session, establishing a communication link between the end node and the CDMA network for the CDMA communication session, and moving the communication session from the wireless access network to the trunk connection. A method may also include the preliminary step of determining whether to handoff the communication session from the wireless access network to the CDMA network prior to taking steps to effect the handoff. A method may also include the steps of indicating to the end node that the handoff from the wireless access network to the CDMA network is successful and passing voice communication from the end node to the CDMA network through the communication link and the trunk connection. The method may also include the step of paging the end node to obtain information for the CDMA network as part of effecting the handoff. A method may also include the step of terminating a communication connection for the wireless access network communication session.

Further embodiments of methods of the present invention are directed to a handoff in the opposite direction and may include an initial step of requesting handoff of a communication session from a CDMA network to VoIP over wireless access network, which request may include transferring end node configuration information and wireless access network information. The method may further include the steps of establishing a communication link with the wireless access network for a wireless access network communication session such as by adding a real time protocol session, establishing a communication link between an end node and the wireless access network for the wireless access network communication session, and moving the communication session from the CDMA network to the wireless access network communication link. A method may also include the preliminary step of determining whether to hand off the communication session from the CDMA network to the wireless access network prior to taking steps to effect the handoff. A method may also include the step of performing a SIP registration process from the end node to the CDMA network as part of effecting the handoff. A method may also include the step of terminating a communication connection for the CDMA communication session as part of effecting the handoff. A method may also include the steps of indicating to the end node that the handoff from the CDMA network to the wireless access network is successful and passing voice communication from the end node to the wireless access network through the communication link.

According to another aspect of the present invention, embodiments of systems capable of handing-off VoIP communication sessions between a wireless access network and a CDMA network are provided. Systems according to the present invention may include a wireless end node, at least one node of the wireless access network, and at least one node of the CDMA network. The nodes of the wireless access network and CDMA network are communicably coupled to the wireless end node. Each of the wireless end node and the nodes of the respective networks include a session handoff module for handing off the communication session of the wireless end node between the wireless access network and the CDMA network. A system may further include a media gateway communicably coupled to at least one of the nodes of the wireless access network and the CDMA network. A system may also include a mobile switching center emulator communicably coupled to at least one of the nodes of the wireless access network and the CDMA network.

According to yet another aspect of the present invention, embodiments of mobile stations capable of VoIP handoff between a wireless access network and a CDMA network are also provided. Mobile stations according to the present invention may include a controller, a wireless communication interface, a system selection module, and a session handoff module. The wireless communication interface may be communicably coupled to the controller and capable of communicating in a wireless access network and a CDMA network. The system selection module may be communicably coupled to a controller and capable of determining whether the mobile station should operate in the wireless access network or the CDMA network. The session handoff module may be communicably coupled to the controller and capable of managing handoff of a communication session between the wireless access network and the CDMA network. The controller may be capable of operating the session handoff module and the system selection module for performing handoff of a communication session between the wireless access network and the CDMA network. The session handoff module may also be capable of requesting a handoff of the communication session between the wireless access network and the CDMA network. The session handoff module may also be capable of providing configuration information about the communication session and the mobile station. The session handoff module may also be capable of moving the communication session between a communication link for the wireless access network and a communication link for the CDMA network.

According to yet another aspect of the present invention, embodiments of servers for handling VoIP handoff between the wireless access network and a CDMA network are provided. Servers according to the present invention may include a controller and a session handoff module. The session handoff module may be communicably coupled to the controller and capable of managing handoff of a communication session between a wireless access network and a CDMA network. The controller may be capable of operating the session handoff module for performing handoff of the communication session between the wireless access network and the CDMA network. The session handoff module may be further capable of establishing a communication link for moving the communication session from an existing communication link to the established communication link. The server may also include a media module communicably coupled to the controller and capable of handling the operation of the communication session over the wireless access network and the CDMA network. The session handoff module may also be capable of generating a wireless access network real time protocol communication link or a CDMA network trunk line communication link. A server may also include a signaling module communicably coupled to the controller, where the signaling module includes the session handoff module. The signaling module may be capable of receiving a handoff request of the communication session and instructing the session handoff module to perform the requested handoff of the communication session.

These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is a diagram of one type of communication network architecture that would benefit from embodiments of the present invention;

FIG. 2 is a control flow diagram illustrating handoff of a communication session of one embodiment of the present invention;

FIG. 3 is a control flow diagram illustrating handoff of a communication session of another embodiment of the present invention;

FIG. 4 is a control flow diagram illustrating handoff of a communication session of yet another embodiment of the present invention;

FIG. 5 is a schematic block diagram of an entity capable of operating as a mobile station or network node in accordance with an embodiment of the present invention; and

FIG. 6 is a schematic block diagram of a mobile station capable of operating in accordance with an embodiment of the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

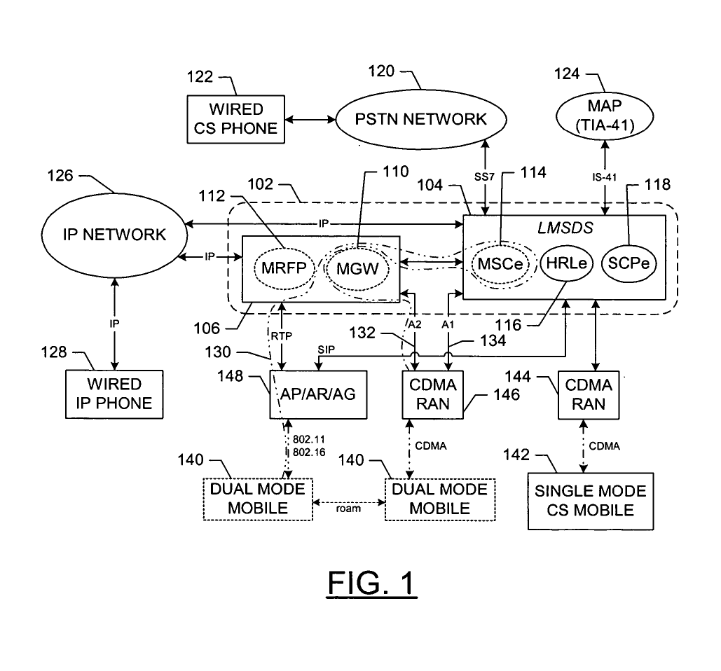

While a primary use of mobile stations of the present invention may be in the field of mobile phone technology, it will be appreciated from the following that many types of wireless end node devices that are generally referenced herein as mobile stations may be used with the present invention, including, for example, mobile phones, voice-capable pagers, voice-capable handheld data terminals and personal data assistants (PDAs), and other voice-capable portable electronics. Further, while the present invention is described below with reference to 802.11 WLAN wireless access sessions and VoIP over WLAN (VoWLAN), the present invention is applicable to VoIP over other wireless access technology, including, but not limited to, 802.16 WiMAX and Bluetooth communication technologies. And although the present invention is described with reference to the network architecture of FIG. 1, the function of the present invention is independent of a particular network architecture, and can function with various network architectures.

The present invention assumes the capability of some mobile stations to be able to operate in two modes, to transmit and receive in a CDMA mode and in a wireless access network mode such as a WLAN mode. A mobile station capable of operating in two modes is referred to as a dual-mode mobile station (DMS), such as a dual-mode mobile phone capable of operating in CDMA and WLAN networks. A communication interface of a dual-mode mobile station, for example, may include a dual mode wireless radio transceiver or separate radio transceivers for operating in CDMA and wireless access networks.

System selection between a CDMA network and a wireless access network for a dual-mode mobile station is not particular to the present invention. A system selection module or like software and/or hardware component of a dual-mode mobile station (DMS) need simply be able to determine in which communication network to operate the dual-mode mobile station (DMS) at any given time to function in accordance with the present invention. For example, a system selection module may determine to operate in a wireless access network, such as a WLAN network, when a wireless access network is available, but to trigger a handoff procedure to a CDMA network when a weak wireless access network signal strength is detected, such as when the mobile station roams away from the available wireless access network coverage. A system selection module may, for example, trigger a handoff procedure to a wireless access network when a dual-mode mobile station (DMS) operating in a CDMA network enters an available wireless access network. Various other system selection schemes may be used in accordance with the present invention.

FIG. 1 is a diagram of one type of a communication network architecture that would benefit from embodiments of the present invention. The network architecture supports handoff of a voice communication session between a wireless access network and a CDMA circuit switched (CS) network, such as VoWLAN to CDMA CS voice. The Legacy Mobile Station Domain Support (LMSDS) architecture as specified in Legacy MS Domain Step 1, 3GPP2 X.S0012-0, Version 2.0 (March 2004) is an example component of a system that would benefit from the present invention and an Legacy Mobile Station Demand Support (LMSDS) network entity is included in FIG. 1. The network includes a Legacy Mobile Station Demand Support (LMSDS) device 104 as an interface between a PSTN network 120 and a MAP network 124. Various other nodes of wireless access and CDMA networks are also included in the network architecture of FIG. 1, as describe further below. Network nodes refer to hardware and/or software components which support a communication network infrastructure. And although generally referring to network servers, the term network nodes is inclusive of such network devices as routers, base stations, switching centers, wireless access points, and other hardware and/or software devices which support a communication network infrastructure.

The LMSDS 104 is connected to a Media Gateway (MGW) 110 and a Media Resource Function Processor (MRFP) 112. As the independent functions of the MGW 110 and MRFP 112 are not clearly defined by the Legacy MS Domain Step 1 architecture, the present invention is described as operating with and/or by a Media Gateway (MGW) and presents the MGW 110 and MRFP 112 as a single MGW-and-MRFP device 106. The description with reference to the operation of the present invention with a MGW, however, is not intended to exclude or differentiate between functions which may be performed by or operations which may be performed with a Media Resource Function Processor (MRFP). Rather, references to a Media Gateway (MGW) are inclusive of the Media Resource Function Processor (MRFP) where appropriate in like manner as the Legacy MS Domain Step 1 document refers to the Media Gateway (MGW) and Media Resource Function Processor (MRFP) as a MGW-and-MRFP rather than one or the other device individually. The LMSDS 104 and MGW-and-MRFP 106 may be independent devices or associated devices, such as in a single LMSDS/MGW-and-MRFP device 102 in a Legacy Mobile Station Domain (LMSD) system.

The LMSDS 104 may include a Mobile Switching Center emulator (MSCe) 114, Home Location Register emulator (HLRe) 116, and Service Control Point emulator (SCPe) 118. The above described network architecture, network devices, and network elements are further described in Legacy MS Domain Step 1. Networks in addition to the PSTN network 120 and the MAP network 124 may be attached to the LMSDS 104 and/or MGW-and-MRFP 106, such as an IP network 126, a wireless access network 148 through one or more access points (AP), access routing (AR), and/or access gateways (AG), and CDMA radio access networks 144, 146 through base stations.

Wired and wireless stations such as phones may be networked and internetworked using the architecture of FIG. 1. For example, a wired circuit switched (CS) phone 122 may be connected to the PSTN network 120 and internetworked to the IP network 126, wireless access network 148, and CDMA radio access networks 144, 146 through the LMSDS 104. A wired IP phone 128 may be similarly connected through the IP network 126. Mobile stations, such as a single-mode circuit switched (CS) mobile station 142 and a dual-mode mobile station (DMS) 140, may also be networked and internetworked using the architecture of FIG. 1. For example, a single-mode CS mobile phone 142 may be connected through a base station of a CDMA radio access network (CDMA RAN) 144 using CDMA wireless signaling protocols. Similarly, a dual-mode mobile station (DMS) 140 may be connected through an access point (AP), access routing (AR), and/or access gateway (AG) of a wireless access network 148 and a base station of a CDMA radio access network (CDMA RAN) 146. The communication of the dual-mode mobile station (DMS) 140 to the CDMA radio access network (CDMA RAN) 146 uses CDMA wireless communication technology. The communication of the dual-mode mobile station (DMS) 140 to the wireless access network 148 may use wireless technology such as 802.11 WLAN or 802.16 WiMAX. The ability of the dual mode mobile phone to communicate with more than one network, allows the dual-mode mobile station (DMS) 140 to roam between networks, such as the dual-mode mobile station (DMS) 140 roaming between the wireless access network 148 and the CDMA radio access network (CDMA RAN) 146.

To facilitate handoff between a wireless access network and a CDMA network in accordance with the present invention, the media gateway 110, media resource function processor 112, mobile switching center emulator 114, and dual mode mobile station 140 may be modified or enhanced to support the handoff functionality of the present invention. To permit consistent handling of voice calls, mobile stations should signal through the LMSDS 104, such as through the MSCe 114, when setting up a voice call to permit the LMSD system to keep track of call states. This permits the LMSD system and elements thereof to reuse known call states to facilitate handoffs. By connecting the two ends of a call at a fixed node, such as a Media Gateway (MGW) or other intermediary node, the two ends of the call operate independently. The handoff processes of the present invention can occur for one end of the call irrespective of the type of connection on the other end of the call and without modifying the connection of the other end of the call with the intermediary node. For example, a handoff of the present invention can occur regardless of whether the caller on the other end of the line is a wireline VoIP phone, a conventional PSTN phone, a CDMA circuit switch phone, a dual-mode CDMA/WLAN phone, or any other phone.

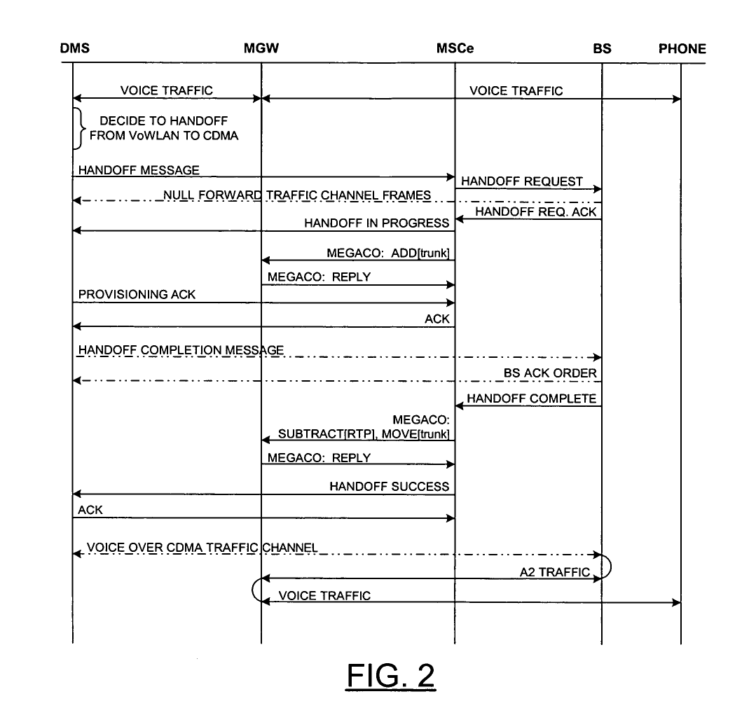

FIG. 2 is a control flow diagram illustrating handoff of a communication session of one embodiment of the present invention. Specifically, the control flow diagram illustrates handoff of a communication session of a dual mode mobile station (DMS) communicating through a wireless access network to the communication session of the dual-mode mobile station (DMS) communicating through a CDMA network, such as an active VoIP session over WLAN (VoWLAN) to a CDMA circuit switched voice call over a CDMA network. The process illustrated in the call flow diagram of FIG. 2 does not require a new call to be established for transferring the communication session from the wireless access network to the CDMA network. Rather, the mobile station provides sufficient handoff information in a signaling message to the Mobile Switching Center emulator (MSCe) to perform handoff of the communication session which may be transparent to the user.

The control flow diagram in FIG. 2 presumes an established communication session as indicated by voice traffic between the dual-mode mobile station (DMS) and a second phone transmitted through a Mobile Gateway (MGW). For example, the voice payload between the Media Gateway (MGW) and the wireless access network may be transmitted through a Real Time Protocol (RTP) connection. The voice payload may be transmitted from the mobile station to the wireless access network using any available wireless access communication technologies, such as 802.11 WLAN, 8012.16 WiMAX, and Bluetooth.

The voice traffic from the mobile station and the second phone, regardless of the type of communication session or the types of mobile stations involved, is terminated at the Media Gateway (MGW), or similar intermediary node. For example, even if the mobile station is in a VoIP call, even if the mobile station and second phone are VoIP phones such that the communication session is a VoIP call between two VoIP phones, and even if the second phone is a PSTN phone or single-mode cellular circuit switched phone, the two sides of the communication session, that is the voice traffic from the dual mode mobile station (DMS) and the voice traffic from the second phone, are terminated at an intermediary device such as the Media Gateway (MGW). This is different from a traditional Real Time Protocol (RTP) session that is terminated between the two VoIP phones. Rather, the Media Gateway (MGW) or like intermediary node serves as a media relay node for the communication session, such as the VoIP call.

By using an intermediary node, such as the Media Gateway (MGW), the communication session between the mobile station and the second phone is broken into two independent communication sessions, one from the mobile station to the Media Gateway (MGW) and one from the Media Gateway (MGW) to the second phone. Voice traffic between the mobile station and the second phone always goes through an intermediary node, the Media Gateway (MGW) in FIG. 2. Although this is contrary to a traditional end-to-end media path, the separation of the two sides of the communication session enables seamless handoff of one or both sides of the communication session from one network to another, such as from a VoIP Real Time Protocol (RTP) session on a wireless access network to a circuit switched T1/E1 connection on a CDMA network. Further, by using an intermediary node such as a Media Gateway (MGW), the network architecture supports media codec translation such as if both end nodes use different voice encoding protocols (VoCODECs). If no codec translation is required, the intermediary node, such as the MGW or MSCe, will simply relay the Real Time Protocol (RTP) packets from one side of the communication session to the other side of the communication session by replacing the destination and source IP addresses. If no codec translation is required, the intermediary node does not need to look at the payload of the Real Time Protocol (RTP) packets. If media codec translation is required, the intermediary node can process the payload of the Real Time Protocol (RTP) packets to convert from one VoCODEC to another VoCODEC as supported by the two sides of the communication session.

As described with reference in FIG. 1, when a mobile station is establishing a communication session, the SIP signaling path may go through the LMSD system in order to allow the LMSD system to keep track of the call state. This permits the LMSD system to reuse the call state to facilitate handoff when requested by one or both of the end node devices of the call.

For example, when a mobile station involved in a communication session detects a weak signal of the wireless access network in which it is communicating voice traffic to the intermediary node, such as a weak signal from an access point of a wireless access network for transmitting packets of voice payload to a Media Gateway (MGW) using a Real Time Protocol (RTP) session, a system selection module of the Mobile Station can decide to handoff the communication session from the wireless access network 148 to an available CDMA radio access network. Other logic may be performed by a system selection module in a mobile station in order to determine whether to switch from one communication network to another; e.g., whether to switch from VoIP over WLAN (VoWLAN) to a CDMA circuit switched voice call.

When the mobile station (DMS) decides to handoff from the wireless access network to the CDMA network, the mobile station forwards a handoff request message to the Mobile Switching Center emulator (MSCe). The handoff request message, or like signaling message, may include the information of the target base station of the CDMA network and the CDMA radio configuration such that subsequent CDMA call setup delay can be minimized. The handoff request message may also include configuration information, such as identification information, related to the mobile station. The specific implementation of the handoff request message or similar signaling message may be accomplished, for example, by extending a SIP message to achieve the function of initiating a handoff of the communication session. Various other implementations may be used for transmitting a signaling message from a mobile station to a Mobile Switching Center emulator (MSCe) or like signaling node.

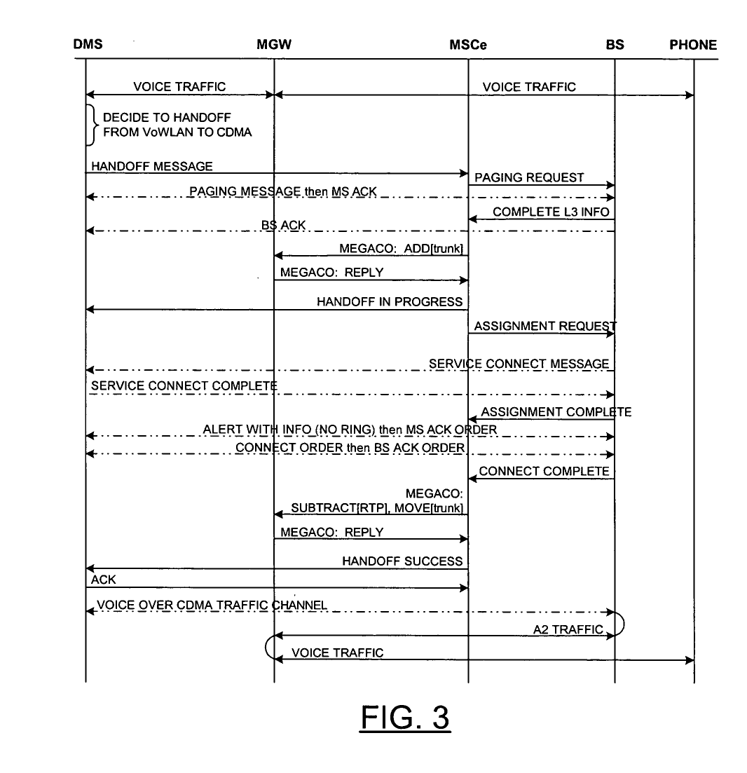

After the Mobile Switching Center emulator (MSCe) receives the handoff request message, the Mobile Switching Center emulator (MSCe) performs steps necessary for the handoff from the wireless access network to CDMA network, such various steps specified in Interoperability Specification (IOS) for cdma2000 Access Network Interfaces—Part 3 Features, 3GPP2 A.S0013-B, Version 1.0 (April 2004), at 3.19.3.1.1 such as (b)-(d) and (j)-(l). In the flow diagram embodiment of FIG. 2, the Mobile Switching Center emulator (MSCe) establishes an A1 connection between the Mobile Switching Center emulator (MSCe) and the CDMA radio access network and send a handoff request message to the target base station in the CDMA radio access network. The handoff request message may include, for example, the mobile station radio configuration information to be used by the target base station and/or other configuration information known by the MSCe or provided to the MSCe by the Mobile Station in the original handoff request message. Alternatively, as illustrated with respect to FIG. 3, the handoff process may use the CDMA MS terminated call procedure rather than the CDMA handoff process; if the handoff request message from the mobile station (DMS) to the Mobile Switching Center emulator (MSCe) does not contain the CDMA channel identity element, the base station (BS) may allocate an appropriate radio resource for the CDMA call and return the CDMA channel identity element in a handoff request acknowledgement message to the Mobile Switching Center emulator (MSCe) to pass to the mobile station (DMS) which will inform the mobile station to tune to the radio channel allocated by the base station (BS). The base station begins sending null forward traffic channel frames to the mobile station over the CDMA air interface. The null forward traffic channel frames are sent from the base station to the mobile station in order to alert the mobile station that the base station is ready for use when handing off to CDMA operations. The base station will also send a handoff request acknowledgement message back to the Mobile Switching Center emulator (MSCe).

The Mobile Switching Center emulator (MSCe) then sends a handoff in progress message to the mobile station (DMS) over the wireless access network communication link, such as over a WLAN connection. The handoff in progress message may act like a Universal Handoff Direct Message (UHDM) in CDMA and contain the necessary information to direct the mobile station to handoff to the target base station. For example, the handoff in progress message can contain the CDMA channel identity element provided by the base station to the Mobile Switching Center emulator (MSCe) related to the appropriate radio resource allocated by the base station to establish the CDMA circuit switched voice call.

The Mobile Switching Center emulator (MSCe) also instructs the Media Gateway (MGW) to add an A2 trunk connection to the CDMA radio access network for the subsequent terrestrial connection. This can be achieved, for example, by a Media Gateway Control (MEGACO) ADD command which is acknowledged by the media gateway (MGW) by sending a MEGACO reply back to the Mobile Switching Center emulator (MSCe). The mobile station may send a provisional acknowledgement message back to the Mobile Switching Center emulator (MSCe) in response to the handoff in progress message. The provisional acknowledgement message may, for example, map to an MS acknowledgement order message in the CDMA handoff procedure. The Mobile Switching Center emulator (MSCe) may send back an acknowledgement of the provisioning acknowledgement to the mobile station. The addition of the A2 trunk connection can occur before, after, or during the handoff in progress message and provisioning acknowledgement between the MSCe and the DMS, but typically occurs before the provisioning acknowledgement.

The mobile station may then send a handoff completion message to the base station over the CDMA air interface, and the base station may send an acknowledgement order back to the mobile station. The base station may then send a handoff complete message to the Mobile Switching Center emulator (MSCe) to notify the MSCe that the mobile station has successfully completed the handoff to the base station. Upon receiving the handoff completion message from the base station, the Mobile Switching Center emulator (MSCe) may instruct the Media Gateway (MGW) to switch the media connection for the voice communication session from the Real Time Protocol (RTP) session with the wireless access network to the A2 trunk connection with the CDMA network. This can be accomplished, for example, using Media Gateway Control (MEGACO) commands such as a MOVE command to move the media connection to the A2 trunk connection and a SUBTRACT command to remove the Real Time Protocol (RTP) session and port. After switching the media connection to the A2 trunk connection and removing the Real Time Protocol (RTP) session and port, the Media Gateway (MGW) may send a Media Gateway Control (MEGACO) reply back to the Mobile Switching Center emulator (MSCe). The Mobile Switching Center emulator (MSCe) is then aware that the handoff from the wireless access network to the CDMA network has successfully finished and may send a handoff success message to the mobile station. Upon receiving the handoff success message from the Mobile Switching Center emulator (MSCe), the mobile station may redirect the voice traffic to the CDMA air interface and clean up the resources for the wireless access network communication session, such as turning off the WLAN driver for the VoWLAN session. The mobile station can acknowledge the handoff success message by sending an acknowledgement message to the Mobile Switching Center emulator (MSCe).

The subsequent traffic flow from the mobile station (DMS) to the second phone after the handoff proceeds from the mobile station (BS) to the base station through the CDMA air interface rather than through the wireless access network connection to the Media Gateway (MGW). The traffic flow continues from the base station to the Media Gateway (MGW) through the A2 trunk connection to continue using an intermediary node, the Media Gateway (MGW), as a terminating point for the two sides of the communication session. The voice traffic between the second phone and the Media Gateway (MGW) is uninterrupted during this process. In such a manner, the two sides of the communication session can be controlled, including handoff from one communication network to another communication network, independently from the other side of the communication session. This process as described may be completely transparent to the user of the other phone, and may also be automatic and/or transparent to the user of the mobile station which switches from the wireless access network to the CDMA network. Alternatively, the user may be able to select or determine to switch from the wireless access network to the CDMA network or may be aware of the handoff between the networks.

In summary, a mobile station that decides to handoff from a wireless access network to a CDMA network coordinates call flow from the communication session between the mobile station and an intermediary node, such as a Mobile Gateway (MGW), with the intermediary node, or a signaling node associated with the intermediary node, such as a Mobile Switching Center emulator (MSCe). The mobile station works with the intermediary node, or signaling node, to move the communication session from a Real Time Protocol (RTP) session between the mobile station and the media gateway (MGW) to a CDMA air interface connection between the mobile station and the base station and an A2 trunk connection to continue the traffic flow from the base station to the Media Gateway (MGW). Accordingly, the traffic flow from the mobile station persists to terminate at the intermediary node, the Media Gateway (MGW) in FIG. 2.

FIG. 3 is a control flow diagram illustrating handoff of a communication session of another embodiment of the present invention. The call flow in FIG. 3 is an alternative method to the call flow described in FIG. 2. The call flow diagram in FIG. 3 follows the CDMA MS terminated call process, such as described in Interoperability Specification (IOS) for cdma2000 Access Network Interfaces—Part 3 Features, 3GPP2 A.S0013-B, Version 1.0 (April 2004), at 3.1.2.1, after the Mobile Switching Center emulator (MSCe) receives the handoff request message from the mobile station, rather than treating the handoff as a CDMA handoff procedure as described above. The dual-mode mobile station (DMS) in FIG. 3, like the DMS in FIG. 2, is in an active VoIP session, such as a VoWLAN communication session, originating at the mobile station and passing through an intermediary node, the Media Gateway (MGW), and terminating at a second phone. As described with reference to the call flow diagram of FIG. 2, the communication session is broken into two segments on either side of the intermediary node, the Media Gateway (MGW). Further, the communication connection between the second phone and the intermediary node, the Media Gateway (MGW), does not affect the communication connection between the mobile station and the Media Gateway (MGW), and any handoff of the communication session between the mobile station and the Media Gateway (MGW), such as handing off the communication session from a Real Time Protocol (RTP) session of a wireless access network to a CDMA air interface communication session between the mobile station and a target base station of the CDMA network continuing through an A2 trunk connection to the Media Gateway (MGW). Again, as in the call flow of FIG. 2, the voice traffic path and voice payload should always go through an intermediary node, the Media Gateway (MGW) in FIG. 3. When the mobile station decides to handoff from a wireless access network to a CDMA network, such as handing off from a VoWLAN session to a CDMA air interface session, the mobile station passes a handoff request message to the Mobile Switching Center emulator (MSCe). The handoff request message from the mobile station to the Mobile Switching Center emulator (MSCe) may include information about the target base station and information about the CDMA radio configuration such that subsequent CDMA call setup delay can be minimized.

After the Mobile Switching Center emulator (MSCe) receives the handoff request message, the Mobile Switching Center emulator (MSCe) perform the steps needed for CDMA MS terminated call process, such as specified in 3GPP2 standards. Specifically, the Mobile Switching Center emulator (MSCe) may establish an A1 signaling path connection to send a paging request message to the base station. The base station may then send a paging message to the mobile station, which the mobile station can acknowledge. This process is a layer 3 (L3) protocol signaling process for the call setup. For example, when the mobile station sends the paging message acknowledgement, the message may include such information as the mobile identification, capability information of the mobile station, tunnel preference information, and connection parameters. In such a manner, the paging process allows the base station to acquire the L3 information from the mobile station in order to establish a new call over the CDMA interface. By comparison, in the call flow of FIG. 2, the handoff message from the mobile station to the Mobile Switching Center emulator (MSCe) includes parameters to set up the CDMA call which are conveyed from the mobile station to the MSCe and from the MSCe to the base station, so no new call setup process is necessary, but a CDMA handoff procedure can be performed. After the base station receives the complete L3 information in the mobile station acknowledgement to the paging message, the base station may send an acknowledgement order message to the mobile station over the CDMA air interface. The base station may also send the complete L3 information back to the Mobile Switching Center emulator (MSCe).

Upon receiving the complete L3 information from the base station, the Mobile Switching Center emulator (MSCe) may instruct the Media Gateway (MGW) to add an A2 trunk connection for the subsequent terrestrial connection between the Media Gateway (MGW) and the base station. This can be achieved, for example, by a Media Gateway Control (MEGACO) ADD command. The media gateway may send a Media Gateway Control (MEGACO) reply message back to the mobile switching center emulator to acknowledge the MEGACO command to add the A2 trunk connection. The Mobile Switching Center emulator (MSCe) may then send a handoff in progress message back to the mobile station over the wireless access network connection and may send an assignment request message to the base station to request allocation of radio resource for the CDMA air interface connection to the mobile station. The assignment request from the Mobile Switching Center emulator (MSCe) to the base station also includes the terrestrial circuit to the base station to permit the base station to communicate with the Media Gateway (MGW) through the established A2 trunk connection.

The target base station and the mobile station continue the standard CDMA MS terminated call process, and the base station can send a service connect message to the mobile station, which the mobile station can acknowledge with a service connect completion message to the base station. In response to the assignment request message from the Mobile Switching Center emulator (MSCe), the target base station may send an assignment complete message to the Mobile Switching Center emulator (MSCe) to acknowledge the completion of the service connection process which occurs over the CDMA air interface between the base station and the mobile station. The base station may also then send an alert message with information to the mobile station. Typically, an alert message would be intended to trigger the mobile station to ring; however, as this is an ongoing call, the mobile station should not ring, but simply continue the handoff process from the wireless access network to the CDMA network. The mobile station may send back an acknowledgement of the received alert message to the base station. The mobile station and base station can then communicate a connection order and a base station acknowledgement order, respectfully. Continuing the CDMA MS terminated call process, the base station may send a connect complete message to the Mobile Switching Center emulator (MSCe) after the CDMA MS terminated call process is completed.

The Mobile Switching Center emulator (MSCe) may then instruct the Media Gateway (MGW) to move the communication connection from the Real Time Protocol (RTP) session with the wireless access network to the A2 trunk connection with the COMA network. This can be achieved, for example, using a Media Gateway Control (MEGACO) MOVE command. The Mobile Switching Center emulator (MSCe) also instructs the Media Gateway (MGW) to remove the Real Time Protocol (RTP) connection with the mobile station, such as using the Media Gateway Control (MEGACO) SUBTRACT command.

The Mobile Switching Center emulator (MSCe) may then send a handoff success message to the mobile station, which the mobile station can acknowledge. The receipt of the handoff success message by the mobile station informs the mobile station that it can then clean up the SIP and Real Time Protocol (RTP) resources used for the wireless access network communication session and complete the handoff process by transferring the communication session to the CDMA air interface with the target base station. As part of cleaning up the wireless access network resources, for example, a wireless access network driver such as a WLAN driver can be turned off.

Performing the handoff process using the CDMA MS terminated call process rather than the CDMA handoff procedure of FIG. 2 may incur additional time for the service connect process, but may be easier to implement on the network level. However, as with the call flow diagram of FIG. 2 and the handoff process described therein, handing off one or both sides of the communication connection between the mobile station and the second phone in accordance with the present invention does not cause the call to be dropped or disrupted, but may possibly only incur a slight delay due to the handoff procedure. A similar call flow process may be used to handoff a communication session from a CDMA network to a wireless access network as described below.

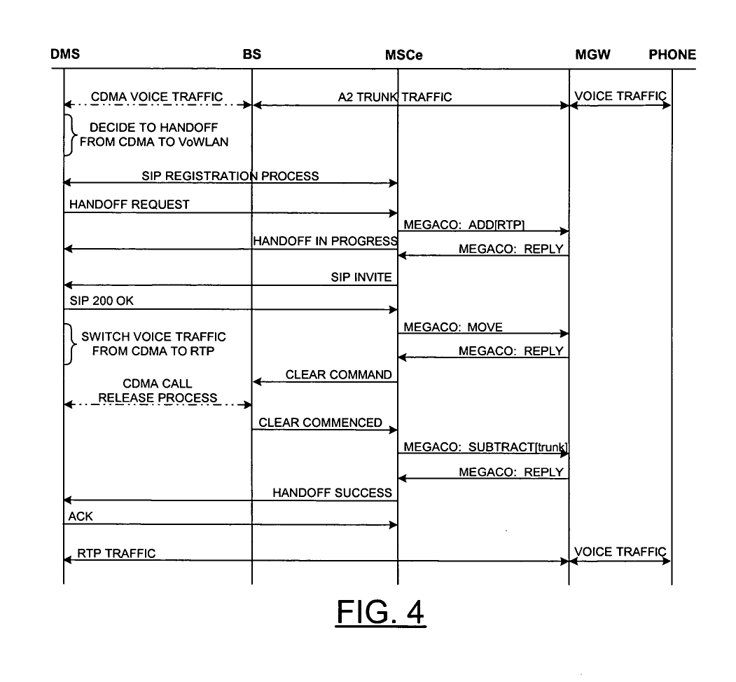

FIG. 4 is a control flow diagram illustrating handoff of the communication session of yet another embodiment of the present invention. The control flow diagram depicts the detail of a message flow during handoff from a CDMA network to a wireless access network, that is, for example, from an active CDMA circuit switched voice call to a VoWLAN session. The dual-mode mobile station (DMS) is necessarily in an available CDMA coverage and in an active Circuit Switched (CS) voice call in the CDMA network. The traffic flow is carried over the CDMA air interface between the mobile station and a base station of the CDMA network. The base station passes the voice traffic from the mobile station across an A2 trunk line to the Media Gateway (MGW). As with the call flow diagrams of FIG. 2 and FIG. 3, the second phone in the communication connection can be any type of phone and may use any type of communication connection to the Media Gateway (MGW). By using an intermediary node, the Media Gateway (MGW) in FIG. 4, the two sides of the communication connection can operate independently, such as handing off from the CDMA network to a wireless access network. And again, as in the call flows of FIG. 2 and FIG. 3, the voice traffic path should always go through the intermediary node, from either side of the communication connection. The mobile station may include a system selection module in order to determine whether to handoff the communication connection from the CDMA network to a wireless access. For example, if the mobile station roams into a wireless access network coverage, such as a WLAN coverage, the system selection module may determine to handoff the communication connection from the CDMA network to the wireless access network, to an access point in the WLAN network. Accordingly, the mobile station may activate a driver and other resources necessary to establish the link connection to the wireless access network. For example, the mobile station may activate a WLAN driver to establish a connection to the access point (AP) in the WLAN wireless access network and to obtain an IP address for the mobile station in the wireless access network. The mobile station may then send a SIP registration message to the Mobile Switching Center emulator (MSCe) to perform the registration process.

After the SIP registration process, the mobile station may send a handoff request message to the Mobile Switching Center emulator (MSCe). The handoff message should include information about the existing CDMA call, including information for a target base station, the CDMA call identification, and the mobile station identification to facilitate CDMA call release. After the Mobile Switching Center emulator (MSCe) receives the handoff request message from the mobile station, the Mobile Switching Center emulator may instruct the Media Gateway (MGW) to add a communication link to the wireless access network, such as a Real Time Protocol (RTP) connection for a VoIP session. This can be achieved, for example, by a Media Gateway Control (MEGACO) ADD command. The Mobile Switching Center emulator (MSCe) may also send back a handoff in progress message to the mobile station.

The handoff procedure may continue with the Mobile Switching Center emulator (MSCe) sending a SIP invite message to the mobile station. The invite message may include the Session Description Protocol (SDP) for the Real Time Protocol (RTP) connection parameters and media information. The mobile station may allocate resources based on the SDP offer from the Mobile Switching Center emulator (MSCe), and send a SIP 200 OK message back to the Mobile Switching Center emulator (MSCe). If the Mobile Switching Center emulator (MSCe) accepts the SDP offer, the Mobile Switching Center emulator can instruct the Media Gateway (MGW) to redirect the voice traffic of the communication session from the A2 trunk connection with the CDMA network to the Real Time Protocol (RTP) connection with the wireless access network. The traffic switching can be achieved, for example, by moving the connection to the new MEGACO context. The Mobile Switching Center emulator (MSCe) may also send back an acknowledgement to confirm the SDP offer from the mobile station. When the mobile station receives the SDP offer acknowledgement, the mobile station may redirect the voice traffic of the communication session from the CDMA air interface to the base station of the CDMA network to the Real Time Protocol (RTP) port of the wireless access network.

The Mobile Switching Center emulator (MSCe) is then ready to release the CDMA call. The Mobile Switching Center emulator (MSCe) may send a clear command to the base station. From the perspective of the base station, the clear command is a network initiated call release. The base station performs a call release procedure with the mobile station, such as the call release procedure as specified in 3GPP2 standards. When the base station completes the call release procedure, the base station sends a clear complete message back to the Mobile Switching Center emulator (MSCe). Upon receiving the clear complete message, the Mobile Switching Center emulator (MSCe) may instruct the Media Gateway (MGW) to close the media connection to the base station, such as by performing a MEGACO SUBTRACT command to remove the A2 trunk connection.

When the Mobile Switching Center emulator (MSCe) knows that the handoff process has successfully finished, the Mobile Switching Center emulator (MSCe) may send a handoff success message to the mobile station in response to the original handoff request message from the mobile station. Upon receiving the handoff success message, the mobile station may clean up the resources for the CDMA communication session and send an acknowledgement message back to the Mobile Switching Center emulator (MSCe). The voice traffic of the communication session may now be transmitted over the wireless access network to the Media Gateway (MGW) from the mobile station rather than over the CDMA air interface to the base station and then through the A2 trunk connection from the base station to the Media Gateway (MGW). This handoff process is transparent to the second phone on the other end of the communication session and may be automatic and/or transparent to the user of the mobile station.

The handoff procedures of the present invention enable seamless handoff between VoIP over wireless access networks and circuit switched CDMA voice calls. No change is required in the CDMA radio access network for the A1 and A2 interfaces to the CDMA radio access network. The present invention may be easily integrated with a 3GPP2 All-IP core network Multimedia Domain such as an IP Multimedia Subsystem (IMS) and provides for a flexible implementation, as shown, for example, in the different methods of call handoff between a wireless network and a CDMA network. Thus, the handoff procedures of the present invention enable seamless handoff such that an active voice communication session is not interrupted, signaling procedures may be used to set up the call in the CDMA environment, call states from the original call may be maintained to minimize the need to reestablish the call during handoff, and minimal or no change is required in the legacy circuit switch network. Further, the handoff procedures of the present invention permit handoff from a wireless access network to a CDMA network and from a CDMA network to a wireless access network. This provides a complete solution for voice over IP (VoIP) using wireless access networks and CDMA circuit switched voice networks.

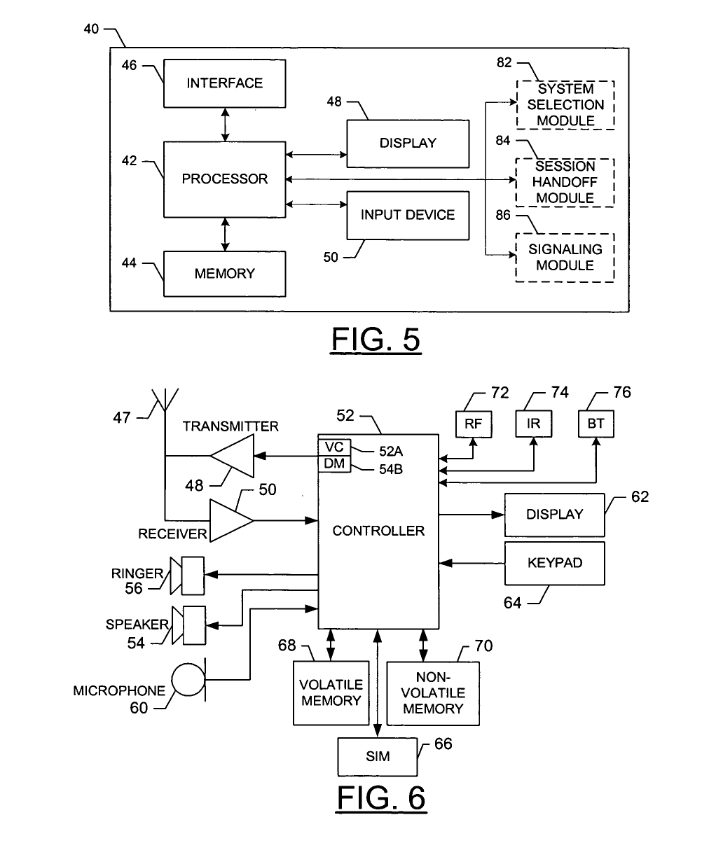

Reference is now made to FIG. 5, which illustrates a block diagram of an entity 40 capable of operating in accordance with VoIP handoff between a wireless access network and a CDMA network of one embodiment of the present invention.

The entity 40 may be, for example, a mobile station, a server or like network node, combinations of these devices, and like network devices and end nodes operating in accordance with embodiments of the present invention. Although shown as separate entities, in some embodiments, one or more entities may support one or more of the entities, logically separated but co-located within one entity. For example, a single entity may support a logically separate, but co-located, LMSDS and MGW-and-MFRP. Similarly, some network entities may be embodied as hardware, software, or combinations of hardware and software components. As shown, the entity 40 can generally include a processor, controller, or the like 42 connected to a memory 44. The memory 44 can include volatile and/or non-volatile memory and typically stores content, data, or the like. For example, the memory 44 typically stores computer program code such as software applications or operating systems, information, data, content, or the like for the processor 42 to perform steps associated with operation of the entity in accordance with embodiments of the present invention. Also, for example, the memory 44 typically stores content transmitted from, or received by, the network node. Memory 44 may be, for example, random access memory (RAM), a hard drive, or other fixed data memory or storage device.

The processor 42 may receive input from an input device 50 and may display information on a display 48. Where the entity 40 provides wireless communication, such as in a CDMA or WLAN network, the processor 42 may operate with a wireless communication subsystem of the interface 46, such as a cellular transceiver. One or more processors, memory, storage devices, and other computer elements may be used in common by a computer system and subsystems, as part of the same platform, or processors may be distributed between a computer system and subsystems, as parts of multiple platforms.

If the entity 40 is, for example, a mobile station, the entity 40 may also include a system selection module 82 and a session handoff module 84 connected to the processor 42. These modules may be software and/or software-hardware components. For example, a system selection module 82 may include software capable of determining whether to switch between available communication networks, such as from a WLAN network to a CDMA network or from a CDMA network to a WLAN network. A session handoff module 84 may include software capable of managing communications between the mobile station and a Mobile Switching Center emulator (MSCe) or other network entity to handoff an active communication session from one network to another network. If the entity 40 is, for example, a server, such as an MSCe, the entity 40 may include a session handoff module 84 and a signaling module 86 connected to the processor 42. These modules may also be software and/or software-hardware components. For example, a signalling module 86 may include software capable of managing signaling communications with an end node, such as a mobile station, and other network entities to initiate and carry out handoff of an active communication session from one network to another network.

FIG. 6 illustrates a functional diagram of a mobile device, or mobile station (MS), capable of operating in accordance with VoIP handoff between a wireless access network and a CDMA network of an embodiment of the present invention. It should be understood, that the mobile device illustrated and hereinafter described is merely illustrative of one type of mobile station that would benefit from the present invention and, therefore, should not be taken to limit the scope of the present invention or the type of devices which may operate in accordance with the present invention. While several embodiments of the mobile device are hereinafter described for purposes of example, other types of mobile stations, such as portable digital assistants (PDAs), pagers, laptop computers, and other types of voice and text communications systems, can readily be employed to function with the present invention. The mobile device shown in FIG. 6 is a more detailed depiction of one version of an entity 40 shown in FIG. 5.

The mobile device includes an antenna 47, a transmitter 48, a receiver 50, and a controller 52 that provides signals to and receives signals from the transmitter 48 and receiver 50, respectively. These signals include signaling information in accordance with the air interface standard of the applicable cellular system or wireless access network and also user speech and/or user generated data. In this regard, the mobile device can be capable of operating with one or more air interface standards, communication protocols, modulation types, and access types. More particularly, the mobile device can be capable of operating in accordance with any of a number of second-generation (2G), 2.5G and/or third-generation (3G) communication protocols or the like. Further, for example, the mobile device can be capable of operating in accordance with any of a number of different wireless networking techniques, including WLAN techniques such as IEEE 802.11, WiMAX techniques such as IEEE 802.16, and the like.

It is understood that the controller 52, such as a processor or the like, includes the circuitry required for implementing the video, audio, and logic functions of the mobile device. For example, the controller may be comprised of a digital signal processor device, a microprocessor device, and various analog to digital converters, digital to analog converters, and other support circuits. The control and signal processing functions of the mobile device are allocated between these devices according to their respective capabilities. The controller 52 thus also includes the functionality to convolutionally encode and interleave message and data prior to modulation and transmission. The controller 52 may include and/or be communicably connected to software modules such as the system selection module 82, session handoff module 84, and signaling module 86 described with respect to FIG. 5. The controller 52 can additionally include an internal voice coder (VC) 52A, and may include an internal data modem (DM) 52B. Further, the controller 52 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile device may also comprise a user interface such as including a conventional earphone or speaker 54, a ringer 56, a microphone 60, a display 62, all of which are coupled to the controller 52. The user input interface, which allows the mobile device to receive data, can comprise any of a number of devices allowing the mobile device to receive data, such as a keypad 64, a touch display (not shown), a microphone 60, or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can further include separate wireless network access transceivers and other local data transfer devices so that data can be shared with and/or obtained from other networks and devices such as other mobile stations, car guidance systems, personal computers, printers, printed materials including barcodes, and the like. For example, the mobile station may include a radio frequency (RF) transceiver 72 capable of sharing data with other radio frequency transceivers, and/or with a Radio Frequency Identification (RFID) transponder tag, as such is known to those skilled in the art. Additionally, or alternatively, the mobile station may share data using an infrared (IR) transceiver 74 or a Bluetooth (BT) transceiver 76 using BT wireless technology developed by the Bluetooth Special Interest Group. Further, the mobile station may be capable of sharing data in accordance with any of a number of different wireline and/or wireless networking techniques, including, for example, LAN, WiMAX, and/or WLAN techniques.

The mobile device can also include memory, such as a subscriber identity module (SIM) 66, a removable user identity module (R-UIM) (not shown), or the like, which typically stores information elements related to a mobile subscriber. In addition to the SIM, the mobile device can include other memory. In this regard, the mobile device can include volatile memory 68, as well as other non-volatile memory 70, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile device. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application, such as a software program or modules for an application, such as to implement a VoIP handoff from a wireless access network to a CDMA network of an embodiment of the present invention, and may store an update for computer program code for the mobile device.

One of ordinary skill in the art will recognize that the present invention may be incorporated into hardware and software systems and subsystems, combinations of hardware systems and subsystems and software systems and subsystems, and incorporated into network systems and mobile stations thereof. In each of these systems and mobile stations, as well as other systems capable of using a system or performing a method of the present invention as described above, the system and mobile station generally may include a computer system including one or more processors that are capable of operating under software control to provide the techniques described above, including VoIP handoff from wireless access networks to CDMA networks. For example, Media Gateway (MGW) may be a media software module; the Mobile Switching Center emulator (MSCe) may be a signaling software module. Accordingly, the two phases of VoIP can be implemented by the Media Gateway (MG) and the Mobile Switching Center emulator (MSCe). Accordingly, the Mobile Switching Center emulator (MSCe) or signaling software module can handle the signaling phase of the VoIP such as operating a SIP signaling protocol through which all signaling and/or handoff messages go through the MSCe. The Media Gateway (MGW) or media software module can handle voice/data transmission, such as VoIP signals in IP protocol sent to the Media Gateway (MGW) or media software module for forwarding to a recipient device and possibly transforming the IP protocol before sending to the recipient device.

Computer program instructions for software control for embodiments of the present invention may be loaded onto a computer or other programmable apparatus to produce a machine, such that the instructions which execute on the computer or other programmable apparatus create means for implementing the functions described herein, such as a mobile station employing VoIP handoff from wireless access networks to CDMA networks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions described herein, such as a method for VoIP handoff from wireless access networks to CDMA networks. It will also be understood that each block or element, and combinations of blocks and/or elements, can be implemented by hardware-based computer systems, software computer program instructions, or combinations of hardware and software which perform the specified functions or steps of establishing dynamic home addressing.

The present invention may be specified, for example, as an extension of the 3GPP2 X.S0012 standard.

Herein provided and described are improved systems, methods, and devices for handing off VoIP sessions and CDMA voice calls between wireless access networks and CDMA networks, thereby providing a user of a mobile device the ability to roam between wireless access networks and CDMA circuit switched voice networks during ongoing communication sessions. The present invention provides a framework that enables seamless handoff between VoIP and circuit switched CDMA voice, including messages and procedures to facilitate such handoffs. Importantly, the voice traffic is not interrupted, and the handoff process may be automatic and transparent to the users of the communication session.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of handing off a communication session of an end node from a wireless access network to a CDMA network, comprising the steps of:
requesting handoff of the communication session from the wireless access network to the CDMA network;
adding a trunk connection for a CDMA communication session;
establishing a communication link between the end node and the CDMA network for the CDMA communication session; and
moving the communication session from the wireless access network to the trunk connection.

2. The method of claim 1, further comprising the step of determining whether to handoff the communication session from the wireless access network to the CDMA network before requesting handoff of the communication session.

3. The method of claim 1, further comprising the step of terminating a communication connection to an intermediary node for the wireless access network communication session following moving the communication session to the trunk connection.

4. The method of claim 1, further comprising the steps of:
indicating to the end node that the handoff from the wireless access network to the CDMA network is successful; and
passing voice communication from the end node to the CDMA network through the communication link and the trunk connection.

5. The method of claim 1, wherein said step of requesting handoff comprises the step of transferring end node configuration information and CDMA network information.

6. The method of claim 1, further comprising the step of paging the end node after a request is made to handoff the communication session and before adding the trunk connection.

7. A method of handing off a communication session of an end node from a CDMA network to a wireless access network, comprising the steps of:
requesting handoff of the communication session from the CDMA network to the wireless access network;
establishing a communication link with the wireless access network for a wireless access network communication session;
establishing a communication link between the end node and the wireless access network for the wireless access network communication session; and
moving the communication session from the CDMA network to the wireless access network communication link.

8. The method of claim 7, further comprising the step of determining whether to handoff the communication session from the CDMA network to the wireless access network before requesting handoff of the communication session.

9. The method of claim 7, further comprising the step of performing a SIP registration process from the end node to the CDMA network.

10. The method of claim 7, further comprising the step of terminating a communication connection to an intermediary node for the CDMA communication session.

11. The method of claim 7, further comprising the steps of:
indicating to the end node that the handoff from the CDMA network to the wireless access network is successful; and
passing voice communication from the end node to the wireless access network through the communication link.

12. The method of claim 7, wherein said step of requesting handoff comprises the step of transferring end node configuration information and wireless access network information.

13. The method of claim 7, wherein said step of establishing a communication link with the wireless access network comprises the step of adding a real time protocol session.

14. A system capable of handing off a communication session of an end node between a wireless access network and a CDMA network, comprising:
a wireless end node;
at least one node of the wireless access network communicably coupled to said wireless end node; and
at least one node of the CDMA network communicably coupled to said wireless end node,
wherein each of said wireless end node and said nodes of said respective networks comprise a session handoff module for handing off the communication session of the wireless end node between the wireless access network and the CDMA network.

15. The system of claim 14, further comprising a media gateway (MGW) communicably coupled to at least one of said node of the wireless access network and said node of the CDMA network.

16. The system of claim 14, further comprising a mobile switching center emulator (MSCe) communicably coupled to at least one of said node of the wireless access network and said node of the CDMA network.

17. The system of claim 16, further comprising a media gateway (MGW) communicably coupled to at least one of said node of the wireless access network and said node of the CDMA network and communicably coupled to said mobile switching center emulator (MSCe).

18. A mobile station, comprising:
a controller;
a wireless communication interface communicably coupled to said controller and capable of communicating in a wireless access network and a CDMA network;
a system selection module communicably coupled to said controller and capable of determining whether the mobile station should operate in the wireless access network or the CDMA network; and
a session handoff module communicably coupled to said controller and capable of managing handoff of a communication session between the wireless access network and the CDMA network,
wherein said controller is capable of operating said session handoff module and said system selection module for performing handoff a communication session between the wireless access network and the CDMA network.

19. The mobile station of claim 18, wherein said session handoff module is further capable of requesting a handoff of the communication session between the wireless access network and the CDMA network.

20. The mobile station of claim 19, wherein said session handoff module is further capable of providing configuration information about the communication session and the mobile station.

21. The mobile station of claim 19, wherein said session handoff module is further capable of moving the communication session between a communication link for the wireless access network and a communication link for the CDMA network.

22. A server, comprising:
a controller for communicating with at least one communication interface of a wireless access network and a communication interface of a CDMA network; and
a session handoff module communicably coupled to said controller and capable of managing handoff of a communication session between the wireless access network and the CDMA network,
wherein said controller is capable of operating said session handoff module for performing handoff of the communication session between the wireless access network and the CDMA network.

23. The server of claim 22, wherein said session handoff module is further capable of establishing a communication link for moving the communication session from an existing communication link to the established communication link.

24. The server of claim 22, further comprising a media module communicably coupled to said controller.

25. The server of claim 24, wherein said media module is capable of handling the operation of the communication session over the wireless access network and the CDMA network.

26. The server of claim 24, wherein said session handoff module is further capable of generating at least one of the communication links selected from the group of: a wireless access network real time protocol communication link and a CDMA network trunk line communication link.

27. The server of claim 22, further comprising a signaling module communicably coupled to said controller, wherein said signaling module comprises said session handoff module.

28. The server of claim 27, wherein said signaling module is capable of receiving a handoff request of the communication session and instructing said session handoff module to perform the requested handoff of the communication session.
